(19) United States
(12) Patent Application Publication
(10) Pub. No.: US 2018/0215930 A1
(43) Pub. Date: Aug. 2, 2018

(54) ANTIMICROBIAL WAX COMPOSITION FOR PROTECTIVE, IMPROVED GRIP AND METHODS OF MAKING AND USING THE SAME

(71) Applicant: Joseph Thomas Fontana, II, Mint Hill, NC (US)

(72) Inventor: Joseph Thomas Fontana, II, Mint Hill, NC (US)

(21) Appl. No.: 15/418,666

(22) Filed: Jan. 27, 2017

(51) Int. Cl. C09D 5/14; C09D 191/06; A01N 25/24; C09D 7/12; A01N 65/00; C09D 7/00; A63B 1/00; A63B 21/072; A63B 21/00; A63B 23/12; B05D 1/28

(52) U.S. Cl. CPC C09D 5/14; C09D 191/06; A01N 25/24; C09D 7/1233; A01N 65/00; B05D 1/28; A63B 1/00; A63B 21/0724; A63B 21/0726; A63B 21/4035; A63B 23/1218; C09D 7/002

(57) ABSTRACT

A protective composition to be applied to exercise equipment for improved grip includes a wax and an antimicrobial agent in an amount effective to inhibit the growth of micro-organisms in the wax in both solid and liquid states. The antimicrobial agent can be in the form of an essential oil suspended in an emulsifier. According to some embodiments of the invention, the wax composition includes an animal or plant based wax that is solid at room temperature, an anti-microbial agent in an amount effective to inhibit the growth of micro-organisms in the wax, and the balance of the composition includes at least one oil that is liquid at room temperature. Numerous other aspects are provided.

### FIELD

The present invention relates to compositions for improved gripping and protecting hands, and more specifically, to methods of making and using such compositions.

### BACKGROUND

It is well known in the prior art that the skin can be repaired by the application of lotions, creams and other emollient compositions. These preparations of the prior art are intended to exert a beautifying, softening, medicinal, and/or lubricating effect on the skin. Other compositions have been described which have the effect of producing a barrier film on the skin which will prevent absorption of harmful or otherwise undesirable substances into the skin. However, the skin creams of the prior art, while effective to some degree, have all suffered from certain disadvantages (none of which significantly protect the hands or enhance grip.

Mere emollients fail to protect the skin from exposure to injurious materials and only serve as palliative remedies afterwards. Barrier creams have been useful for certain specific conditions, but heretofore have failed to protect against abrasion, particularly extended periods of repeated abrasion. Furthermore, in maintaining personal hygiene, for example, by washing the hands, these compositions of the prior art are largely removed and repeated applications are necessary. It is evident that under such conditions any benefits obtained are not lasting and protection from exposure irritants and abrasion may not actually be effective at all since the protection is readily removed. Thus, what are needed are protective compositions for improved gripping and methods of making and using such compositions.

### SUMMARY

In some embodiments, a method of protectively enhancing grip on exercise equipment is provided. The method includes providing a composition including a wax compound and at least one of a softening agent, a thickening agent, an antimicrobial agent, an adhesive agent, and a coloring agent; applying the composition to a hand grip area of exercise equipment; and performing exercise while holding the hand grip area of the exercise equipment.

In some other embodiments, a protective composition for enhancing grip on exercise equipment is provided. The protective composition consists of a wax compound; a softening agent blended with the wax compound and in sufficient proportion to impart softening properties to the composition; an antimicrobial agent blended with the wax compound and in sufficient proportion to impart antimicrobial properties to the composition; and an adhesive agent blended with the wax compound and in sufficient proportion to impart tacky properties to the composition.

In yet other embodiments, a method is provided. The method includes pressing a solid protective composition against a handle of exercise equipment; rubbing the solid protective composition against the handle to deposit a layer of the solid protective composition on the handle; and performing exercise using the exercise equipment with coated handles. The solid protective composition includes a wax compound, a softening agent blended with the wax compound and in sufficient proportion to impart softening properties to the composition, an antimicrobial agent blended with the wax compound and in sufficient proportion to impart antimicrobial properties to the composition, and an adhesive agent blended with the wax compound and in sufficient proportion to impart tacky properties to the composition.

Numerous other aspects are provided in accordance with these and other aspects of the invention. Other features and aspects of the present invention will become more fully apparent from the following detailed description, the appended claims and the accompanying drawings.

### BRIEF DESCRIPTION OF THE DRAWINGS

FIG. 1 is a flowchart depicting an example method according to embodiments of the present invention.

FIG. 2 is an isometric diagram depicting an example of a solid bar form of a protective composition according to embodiments of the present invention.

### DESCRIPTION

For the purposes of promoting an understanding of the principles of embodiments of the invention, reference will now be made to the examples illustrated in the drawings and specific language will be used to describe the same. It will nevertheless be understood that no limitation of the scope of the invention is thereby intended, and any alterations and further modifications in the illustrated embodiments, and any further applications of the principles of the invention as illustrated therein as would normally occur to one skilled in the art to which the invention relates are contemplated herein.

Embodiments of the present invention provide a protective composition to be applied to exercise equipment for improved grip. The novel composition includes a wax and an antimicrobial agent in an amount effective to inhibit the growth of micro-organisms in the wax in both solid and liquid states. In some embodiments, the antimicrobial agent can be in the form of an essential oil suspended in an emulsifier. According to some embodiments of the invention, the wax composition includes an artificial or natural animal or plant based wax that is solid at room temperature, an anti-microbial agent in an amount effective to inhibit the growth of micro-organisms in the wax, and the balance of the composition includes at least one oil that is liquid at room temperature.

When applied to exercise equipment such as, for example, pull-up bars, kettle bells, weight bars, handles of exercise machines, and dumbbells, the composition provides users protection against abrasion, skin shearing, and tearing as well as from bacterial exposure, while at the same time the users' grip is enhanced by the presence of the composition.

The composition can be made from any practicable combination of animal, plant, and/or petroleum derived waxes. Possible types of wax that can be used include animal waxes such as beeswax (e.g., produced by honey bees), Chinese wax (e.g., produced by the scale insect Ceroplastes ceriferus), lanolin (e.g., wool wax from the sebaceous glands of sheep), shellac wax (from the lac insect Kerria lacca), spermaceti (e.g., from the head cavities and blubber of the sperm whale); Vegetable waxes such as bayberry wax (e.g., from the surface wax of the fruits of the bayberry shrub Myrica faya), candelilla wax (e.g., from the Mexican shrubs Euphorbia cerifera and Euphorbia antisyphilitica), Carnauba wax (e.g., from the leaves of the Carnauba palm, Copernicia cerifera), castor wax (e.g., catalytically hydrogenated castor oil), esparto wax (e.g., a byproduct of making paper from esparto grass, Macrochloa tenacissima), Japan wax (e.g., a vegetable triglyceride (not a true wax), from the berries of rhus and toxicodendron species), ouricury wax (e.g., from the Brazilian feather palm, Syagrus coronata), rice bran wax (e.g., obtained from rice bran, oryza sativa), soy wax (e.g., from soybean oil), tallow tree wax (e.g., from the seeds of the tallow tree Triadica sebifera); mineral waxes such as ceresin waxes, montan wax (e.g., extracted from lignite and brown coal), ozocerite (e.g., found in lignite beds), peat waxes; and petroleum waxes such as paraffin wax (e.g., made of long-chain alkane hydrocarbons), and microcrystalline wax (e.g., with very fine crystalline structure).

In some embodiments, one or more oils are combined with the wax compound as a softening agent. The oils can include any combination of almond oil, avocado oil, clarified butter (i.e., ghee), clarified canola oil (e.g., rapeseed oil), coconut oil, corn oil, cottonseed oil, grapeseed oil, hazelnut oil, lard, macadamia nut oil, olive oil, palm oil, peanut oil, rice bran oil, safflower oil, sesame oil, shortening, vegetable soybean oil, sunflower oil, vegetable oil, and/or walnut oil. Other softening agents can be used. In some embodiments, for example, coconut oil is used in the composition as a softening agent. Paraffin wax by itself is a relatively hard wax but it is significantly less expensive than softer beeswax. Adding oil, such as coconut oil, is a cost effective way to obtain an optimal hardness for the composition to support the desired functions described herein. If the end product is too hard, it may be abrasive on the hands and not feel tacky enough. If the product is too soft, it will not provide enough grip, may feel too sticky, and not provide adequate protection against abrasion.

In some embodiments, additional materials can be added to and combined with the wax compound as a thickening agent. The additional materials can include any combination of fecula, vegetable gums, proteins, sugars, and/or functional flours. Other thickening agents can be used. Thickening agents increase the volume of the composition at a reduced cost without degrading the functions of the components. For example, a substance such as corn starch can be used as a thickening agent, when added to the mixture of ingredients. Not only is it a cost effective way to increase the volume of the more expensive ingredients but it also helps the wax build upon itself when applied to the exercise equipment, giving the user the proper thickness need to prevent ripping.

In some embodiments, one or more essential oils are combined with the wax compound to serve as an antimicrobial agent. The essential oils can include any combination of allspice, aniseed, basil, bay, benzoin, bergamot, black pepper, cajuput, calamus, camomile, camphor, caraway, carrot seed, cassia, cedarwood, chamomile, cinnamon, citronella, clary sage, clove, coriander, cypress, dill, eucalyptus, fennel, frankincense, geranium, ginger, grapefruit, helichrysum, hyssop, jasmine, juniper, lavandin, lavender, lemon, lemongrass, lemon verbena, lime, mandarin, marjoram, melissa, myrrh, neroli, niaouli, nutmeg, orange, palma rosa, patchouli, peppermint, petitgrain, pimento, pine, rose, rose geranium, rosemary, rosewood, sage, sandalwood, spearmint, spikenard, tagetes, tangerine, thyme, tea tree, vetiver, ylang-ylang, angelica, birch, bitter almond, boldo, buchu, cardamom, cumin, elemi, mugwort, mustard, oregano, pennyroyal, rose otto, rue, sassafras, tansy, tarragon, savin, thuja, tuberose, vanilla, wintergreen, wormseed, wormwood, yarrow, rosehip oil, baobab oil, marula oil, neem oil, almond oil, aloe vera oil, apricot kernel oil, avocado oil, calendula oil, evening primrose oil, grape seed oil, hazelnut oil, jojoba oil, macadamia oil, olive oil, sesame oil, walnut oil, wheatgerm oil, pumpkin seed oil, safflower oil, and/or sunflower oil. Other antimicrobial agents can be used. Antimicrobials can be broken down into 4 major categories. These include (1) antibacterial, (2) antiviral, (3) antifungal, and (4) antiparasitic agents. Essential oils can help defend against all of these types of microbials. Other chemicals can be used as well. For example, antibacterials include anilides, biguanides, bisphenols, halophenols, heavy metals, phenols, cresols, and quaternary ammonium compounds. Clearly, of these, chemicals in forms and concentrations toxic to humans are not used. For example, antivirals include acyclovir, amixin, arpetol, cymevene, epigen intim, herpevir, oxolin, pegasys, remantide, sumetrolim, univudin, valtrex, viferon, virolex, viusid, vivorax, zovirax, and the like. Clearly, of these, chemicals in forms and concentrations toxic to humans are not used. Essential oils and some other antimicrobials help prevent bacteria, viruses, fungi, and parasites from growing and also aid in softening the end product, as the coconut oil does.

In some embodiments, resin or gums can be added to and combined with the wax compound and may serve as an adhesive agent. The resin or gums can include any combination of gum arabic, gum tragacanth, karaya gum, damar tree resin, gum resin, oleo-gum-resin, oleo-resin, resin, rosin, and/or resinoid. Other adhesive agents can be used.

In some embodiments, color, pigment, or dyes can be added to and combined with the wax compound and may serve as a coloring agent to make the composition easier to see when applied and more appealing to users. For example, a hot pink liquid pigment can be used to color the novel composition. This color not only supports branding but also provides for a functional benefit. Most exercise equipment, to which the composition might be applied, is black. A hot pink or other florescent color allows users to easily see where to put their hands to prevent ripping and slippage. In some embodiments, glow-in-the-dark pigment can be used.

An adhesive agent is used to add tackiness to a harder wax product and can also serve as a binding agent to hold the components of the composition together. Softer waxes feel tackier but may be too soft for optimal performance and grip on exercise equipment. Harder waxes are abrasive and are too slick for optimal performance and grip on exercise equipment.

As indicated above, the composition can include a wax compound, a softening agent, a thickening agent, an antimicrobial agent, an adhesive agent, and a coloring agent. In some embodiments, the composition can include the wax compound at approximately 35 wt % to approximately 95 wt %; the softening agent at approximately 1 wt % to approximately 5 wt %; the thickening agent at approximately 0 wt % to approximately 40 wt %; the antimicrobial agent at approximately 0.01 wt % to approximately 0.5 wt %; the adhesive agent at approximately 5 wt % to approximately 30 wt %; and the coloring agent at approximately 0 wt % to approximately 0.5 wt %. Other composition ratios are possible. Note that 0 wt % indicates that the particular component is optional and may not be present at all in some embodiments. In some embodiments, the composition can include paraffin at approximately 71 wt %; bee's wax at approximately 14 wt %; resin at approximately 11 wt %; coconut oil at approximately 3 wt %; and an essential oil blend at less than approximately 1 wt %. In some embodiments, the essential oil blend can include tea tree, lavender, clove, and oregano.

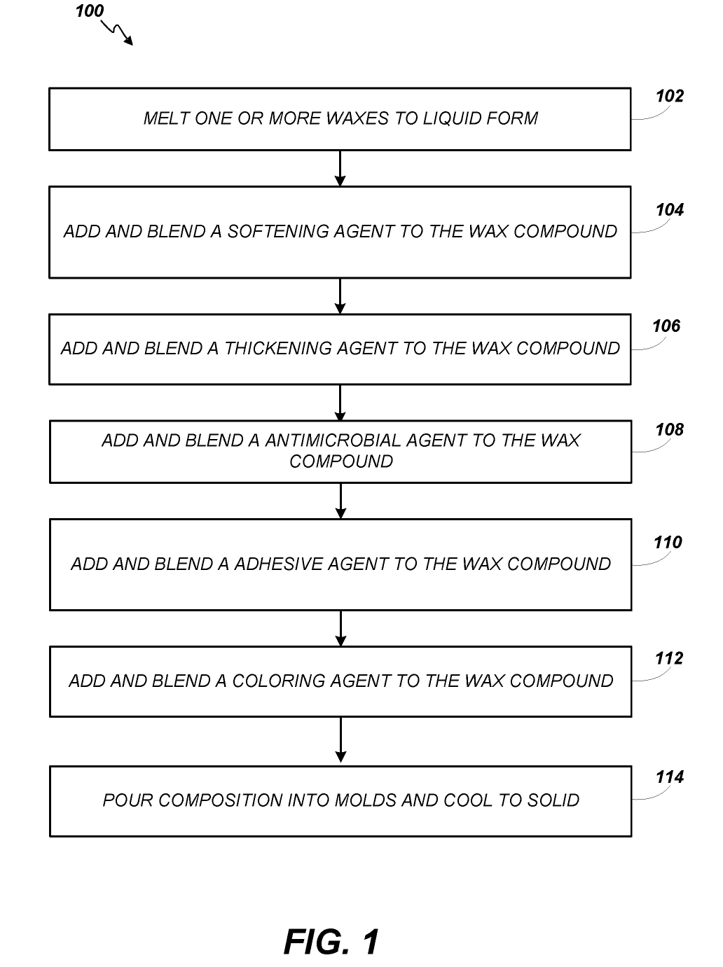

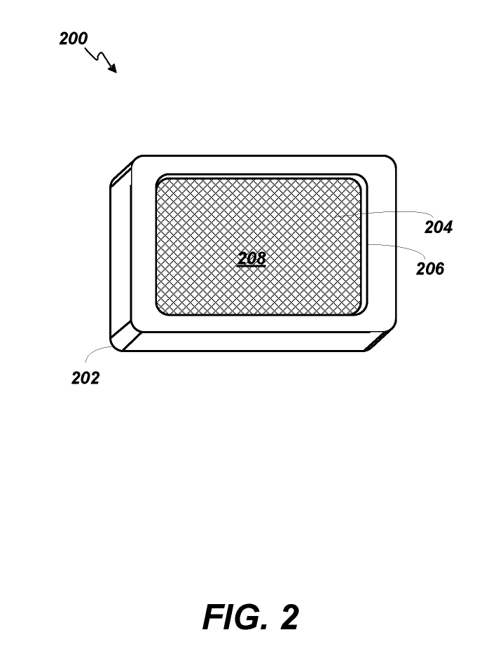

Turning now to FIG. 1, an example method 100 of manufacturing the compositions of embodiments of the present invention is depicted in a flowchart. A wax compound is initially formed by melting one or more waxes to liquid form (102). If more than one type of wax is used, the melted waxes can be mixed to blend the different types into a homogenous mixture. In some embodiments, the wax or waxes can be heated to approximately 180° F. to approximately 250° F. to liquefy them. Other temperatures can be used. The liquefied wax compound can be removed from the heat and a softening agent in the proportions discussed above is added to the wax compound (104). The wax compound and the softening agent can be mixed to blend the components into a homogenous mixture. In some embodiments, a thickening agent in the proportions discussed above can be added to and blended with the mixture (106). In some embodiments, an antimicrobial agent in the proportions discussed above can be added to and blended with the mixture (108). In some embodiments, a liquefied (e.g., via separate heating) adhesive agent in the proportions discussed above can be added to and blended with the mixture (110). In some embodiments, a coloring agent in the proportions discussed above can be added to and blended with the mixture (112). Note that the order of adding the component materials to form the compositions of embodiments of the present invention described above is merely an illustrative sequence and many other practicable sequences are possible. Once the selected components have been combined and blended, the composition is poured into suitable molds (e.g., commercial product-sized bars, approximately 35 grams each) and cooled to ambient temperature to solidify (114). The composition in solid bar form 200 (e.g., as shown in FIG. 2) is then packaged for distribution. The solid bar 200 is suitable for application (e.g., rubbing) of the composition onto handles and grips of exercise equipment. In some embodiments, the solid bar form 200 of the composition can include rounded corners 202 and depressed areas 204, ridges 206, lips, or other surface textures 208 to improve the ability to hold the solid bar 200 during application of the composition to exercise equipment.

In use, the novel composition is applied to the hand grips of any exercise apparatus such as sports equipment, weight-lifting gear, and strength training devices. For example, the composition can be applied to barbells, dumbbells, kettle bell handles, pull-up bars, weight-lifting machine handles, etc. Note that unlike prior art compositions that are applied to the user's hands, the composition of the present invention is applied to the exercise equipment. The composition is adapted to remain on the exercise equipment until specifically removed. While some residue may get on the user's hands, the majority of the novel composition remains on the exercise equipment.

By rubbing the composition in solid form on the hand grips or areas intended to be gripped by the user's hands, a thin layer (e.g., approximately 0.25 mm to approximately 2 mm) of the composition is deposited. For example, if the user is preparing to do pull-up exercises using a pull-up bar, the composition is applied around the entire circumference of the bar in the two places where the user will grip the bar, approximately 10 cm to approximately 15 cm. The composition changes the feel of the bar from a hard ridged bar to a bar with a soft malleable coating that provides the user with a “tacky” or “gummy” padding sensation and at the same time, a lubricating sensation. The overall sensation is that the user has a more comfortable and better grip. The composition serves to protect the user's hands from skin abrasion, skin shear, skin tear, blisters, acute skin trauma, and pressure ulcers. In addition, the antimicrobial agent serves to prevent spread of bacteria and reduces the chance of infection if the user's skin is compromised. In some uses, the composition provides a textured feel to the exercise equipment wherein higher points of the applied material are adjacent to lower points such that the otherwise smooth grip of the exercise equipment becomes more bumpy or coarse, and thus more grip-able so that users can more reliably hold onto the exercise equipment.

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

The Title (set forth at the beginning of the first page of this disclosure) is not to be taken as limiting in any way as the scope of the disclosed invention(s).

The term “product” means any machine, manufacture and/or composition of matter as contemplated by 35 U.S.C. § 101, unless expressly specified otherwise.

Each process (whether called a method, class behavior, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, component, structure, or article is described herein, more than one device, component, structure or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component, structure, or article is described herein (whether or not they cooperate), a single device, component, structure, or article may alternatively be used in place of the more than one device, component, structure, or article that is described. For example, a plurality of computer-based devices may be substituted with a single computer-based device. Accordingly, the various functionality that is described as being possessed by more than one device, component, structure, or article may alternatively be possessed by a single device, component, structure, or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, elements, materials, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

The foregoing description discloses only exemplary embodiments of the invention. Modifications of the above disclosed apparatus and methods which fall within the scope of the invention will be readily apparent to those of ordinary skill in the art. For example, although the examples discussed above are illustrated for an exercise equipment or fitness market, embodiments of the invention can be implemented for other markets.

Accordingly, while the present invention has been disclosed in connection with exemplary embodiments thereof, it should be understood that other embodiments may fall within the spirit and scope of the invention, as defined by the following claims.

What is claimed is:

1. A method of protectively enhancing grip on exercise equipment, the method comprising:
providing a composition including a wax compound and at least one of a softening agent, a thickening agent, an antimicrobial agent, an adhesive agent, and a coloring agent;
applying the composition to a hand grip area of exercise equipment; and
performing exercise while holding the hand grip area of the exercise equipment.

2. The method of claim 1 wherein the composition includes the wax compound at approximately 35 wt % to approximately 95 wt %; the softening agent at approximately 1 wt % to approximately 5 wt %; the thickening agent at approximately 0 wt % to approximately 40 wt %; the antimicrobial agent at approximately 0.01 wt % to approximately 0.5 wt %; the adhesive agent at approximately 5 wt % to approximately 30 wt %; and the coloring agent at approximately 0 wt % to approximately 0.5 wt %.

3. The method of claim 1 wherein the composition includes paraffin at approximately 71 wt %; bee's wax at approximately 14 wt %; resin at approximately 11 wt %; coconut oil at approximately 3 wt %; and an essential oil blend at less than approximately 1 wt %.

4. The method of claim 1 wherein providing a composition includes providing the composition in a solid bar form.

5. The method of claim 4 wherein applying the composition includes rubbing the solid bar form of the composition against the hand grips of the exercise equipment to deposit a layer of composition on the hand grips.

6. The method of claim 5 wherein the deposited layer is 0.25 mm to 2.0 mm thick.

7. The method of claim 5 wherein the exercise equipment includes a barbell.

8. The method of claim 5 herein the exercise equipment includes at least one of a pull-up bar, a kettle bell, a weight bar, a handle of exercise machine, and a dumbbell.

9. A protective composition for enhancing grip on exercise equipment, the composition consisting of:
a wax compound;
a softening agent blended with the wax compound and in sufficient proportion to impart softening properties to the composition;
an antimicrobial agent blended with the wax compound and in sufficient proportion to impart antimicrobial properties to the composition; and
an adhesive agent blended with the wax compound and in sufficient proportion to impart tacky properties to the composition.

10. The protective composition of claim 9 wherein the composition includes the wax compound at approximately 35 wt % to approximately 95 wt %; the softening agent at approximately 1 wt % to approximately 5 wt %; the antimicrobial agent at approximately 0.01 wt % to approximately 0.5 wt %; and the adhesive agent at approximately 5 wt % to approximately 30 wt %.

11. The protective composition of claim 9 wherein the wax compound includes at least one of beeswax and paraffin wax.

12. The protective composition of claim 11 wherein the softening agent includes coconut oil.

13. The protective composition of claim 12 further including corn starch used as a thickening agent.

14. The protective composition of claim 13 wherein the antimicrobial agent includes an essential oil.

15. The protective composition of claim 14 wherein the adhesive agent includes at least one of gum arabic, gum tragacanth, karaya gum, damar tree resin, gum resin, oleo-gum-resin, oleo-resin, resin, rosin, and/or resinoid.

16. The protective composition of claim 15 wherein the agents are combined into a homogeneous composition by heating at 180 degrees to 250 degrees to liquefy the wax compound and then blending the liquid composition.

17. The protective composition of claim 16 wherein the blended liquid composition is poured into bar shaped molds and cooled to a solid state.

18. A method comprising:
pressing a solid protective composition against a handle of exercise equipment;
rubbing the solid protective composition against the handle to deposit a layer of the solid protective composition on the handle; and
performing exercise using the exercise equipment with coated handles,
wherein the solid protective composition includes a wax compound, a softening agent blended with the wax compound and in sufficient proportion to impart softening properties to the composition, an antimicrobial agent blended with the wax compound and in sufficient proportion to impart antimicrobial properties to the composition, and an adhesive agent blended with the wax compound and in sufficient proportion to impart tacky properties to the composition.

19. The method of claim 18 wherein the solid protective composition includes the wax compound at approximately 35 wt % to approximately 95 wt %; the softening agent at approximately 1 wt % to approximately 5 wt %; the antimicrobial agent at approximately 0.01 wt % to approximately 0.5 wt %; and the adhesive agent at approximately 5 wt % to approximately 30 wt %.

20. The method of claim 19 wherein the solid protective composition is in bar form and includes essential oil and a coloring agent.
